(19) United States
(12) Patent Application Publication
(10) Pub. No.: US 2022/0099955 A1
(43) Pub. Date: Mar. 31, 2022

(54) Tunable Liquid Lens

(71) Applicant: Optotune Consumer AG, Dietikon (CH)

(72) Inventors: Stephan Smolka, Dietikon (CH); Frank Bose, Dietikon (CH); Lucas Dreesen, Dietikon (CH)

(73) Assignee: Optotune Consumer AG, Dietikon (CH)

(21) Appl. No.: 17/488,535

(22) Filed: Sep. 29, 2021

(30) Foreign Application Priority Data
Sep. 30, 2020 (DE) 102020125506.3

(51) Int. Cl. G02B 26/00; G02B 3/14

(52) U.S. Cl. CPC G02B 26/005; G02B 3/14

(57) ABSTRACT

Tunable liquid lens (100) comprising
a container (5) delimiting a volume (50), wherein the volume (50) comprises a first liquid (1) and a second liquid (2),
a first interface (12) is formed between the first liquid (1) and the second liquid (2), wherein the first liquid (1) and the second liquid (2) are immediately adjacent,
a second interface (23) is formed between the second liquid (2) and a third liquid (3), wherein the second liquid (2) and the third liquid (3) are immediately adjacent or the second liquid (2) and the third liquid (3) are adjacent to opposite sides of a membrane (30),
the optical power of the lens (100) is adjustable by altering the curvature of the first interface (12) and/or the second interface (23), and
the refractive indices and the mass densities of the first liquid (1), the second liquid (2) and the third liquid (3) and the stiffness of the membrane (30) are adjusted to compensate for coma induced by acceleration forces (99).

### CROSS-REFERENCE TO RELATED APPLICATIONS

Benefit is claimed to German Patent Application No. 102020125506.3, filed Sep. 30, 2020, the contents of which are incorporated by reference herein in their entirety.

### FIELD

Conventional optical components have optical surfaces with predefined shapes. Liquid lenses enable to change shapes of optical surfaces. In particular, optical properties of a liquid lens may be tuned by altering the shape of at least one optical surface. Thus, the optical properties may be adjusted to the requirements in a particular situation while the tunable lens is in operation. Hence, particularly fast adaption with smooth transition between the tuning states results in a particularly versatile optical component.

### BACKGROUND

A liquid tunable lens described herein is based, among other things, on the following considerations.

Tuning of a tunable lens alters a dedicated optical property and additionally introduces changes in optical aberrations. Thus, designing optical systems comprising a tunable lens is particularly challenging.

Among other things, the liquid tunable lens described herein makes use of the idea that the first interface may compensate for optical aberrations introduced by the second interface or vice versa. In particular, the second interface may compensate gravitational coma of the first interface.

Advantageously, the liquid tunable lens has particularly low aberrations, for example particularly low coma. Thus, the present tunable liquid lens allows imaging with particularly high image quality.

### SUMMARY

A tunable liquid lens is described here and in the following. The tunable liquid lens is a refractive optical device, which comprises at least one liquid material which allows to alter an optical property of the tunable liquid lens intentionally. The optical property may be the optical power.

According to one embodiment, the lens comprises a container delimiting a volume. In particular, the container delimits the volume completely on all sides. Along an optical axis of the tunable liquid lens the container is transparent for electromagnetic radiation in a visible wavelength range. The container comprises a window element, which delimits the volume on one side. In particular, the container may comprise two window elements which delimit the volume on opposite sides of the volume.

The volume comprises a first liquid and a second liquid. In particular the first liquid and the second liquid are immiscible. For example, the first liquid is a hydrophobic liquid and the second liquid is a hydrophilic liquid or vice versa. A first interface is formed between the first liquid and the second liquid. The first liquid and the second liquid may be immediately adjacent. Here and in the following “immediately adjacent” describes an arrangement, wherein the first liquid and the second liquid are in direct contact and no structural barrier except for the liquids' surface tension separates the liquids which are immediately adjacent to each other.

A second interface is formed between the second liquid and a third liquid. According to a first alternative, the second liquid and the third liquid may be immediately adjacent to each other. In particular, the second and the third liquid are immiscible with each other. According to a second alternative, the second liquid and the third liquid are adjacent to opposite sides of a membrane. In particular, the membrane forms the second interface. The membrane is transparent for electromagnetic radiation in a visible wavelength range.

The second liquid is arranged between the first and the third liquid. The first, the second and the third liquid are transparent for electromagnetic radiation in a visible wavelength range. The first liquid has a first refractive index, the second liquid has a second refractive index and the third liquid has a third refractive index. In particular, the second refractive index is different from the first and the third refractive index. Said difference may be at least 0.01. Thus, light is being refracted at the first interface and at the second interface. For example, the first refractive index, the second refractive index and the third refractive index is in a range from 1.2 to 1.6. The first liquid, the second liquid and the third liquid may have an Abbe Number from 30 to 120.

The curvature of the first and the second interface is adjustable. Adjusting the curvature of the first and the second interface enables to alter the optical power of the liquid tunable lens.

The first liquid has a first mass density, the second liquid has as a second mass density and the third liquid has a third mass density. The refractive indices and the mass densities of the first, the second and the third liquid and the stiffness of the membrane, if a membrane forms the second interface, are adjusted to compensate for coma induced by acceleration forces. Here and in the following acceleration forces comprise gravitational acceleration. In particular, the said properties are selected such, that gravitationally induced coma is compensated passively.

The optical power of the lens is adjustable by altering the curvature of the first interface and/or the second interface. The curvature s may be altered by means of electrowetting. Here and in the following the term “electrowetting” refers to a modification of the wetting properties of a surface (which is typically hydrophobic) with an applied electric field. For example, the container may comprise electrodes to which an electric field is applied to modify the wetting properties of the sidewalls of the container. By adjusting the contact angle of the first and the second liquid and/or the second and the third liquid, the curvature of the first interface and/or the second interface is altered. If the second interface is formed by a membrane, the curvature may be adjusted by moving second liquid or third liquid. For example, a lens shaper pushes against the membrane along the optical axis. By pushing against the membrane, the curvature of the membrane is altered. The curvature of the membrane may be adjusted by displacement of the liquid. The liquid may be displaced by means of the lens shaper, which is arranged to apply a pressure on a surface of the membrane. For example, the lens shaper has a frame like shape, wherein the frame like shape surrounds a portion of the membrane. The portion of the membrane may change its curvature, when the liquid is displaced by means of the lens shaper. The liquid may be displaced by means of a pumping device. The pumping device is arranged to move liquid in the container, which may cause a dedicated deformation of the membrane.

According to an embodiment of the tunable liquid lens comprises the container delimiting a volume, wherein the volume comprises the first liquid and the second liquid. The first interface is formed between the first liquid and the second liquid, wherein the first liquid and the second liquid are immediately adjacent. The second interface is formed between the second liquid and the third liquid, wherein the second liquid and the third liquid are immediately adjacent to each other or the second liquid and the third liquid are adjacent to opposite sides of the membrane. The optical power of the lens is adjustable by altering the curvature of the first interface and/or the second interface, and the refractive indices and the mass densities of the first liquid, the second liquid and the third liquid and the stiffness of the membrane are adjusted to compensate for coma induced by acceleration forces.

According to one embodiment, the first liquid has a first refractive index and a first mass density, the second liquid has a second refractive index and a second mass density. According to a first alternative the first mass density is smaller than the second mass density, and the first refractive index is larger than the second refractive index. According to a second alternative the first mass density is larger than the second mass density, and the first refractive index is smaller than the second refractive index.

Further advantages and advantageous refinements and developments of the liquid tunable lens result from the following exemplary embodiments illustrated in connection with the figures.

### BRIEF DESCRIPTION OF THE DRAWINGS

FIG. 1 shows an exemplary embodiment of a liquid tunable lens, wherein the third liquid is air;

FIGS. 2 and 3 show exemplary embodiments of the liquid tunable lens, wherein the curvature of the first and the second interface are controlled by means of electrowetting;

FIGS. 4 and 5 show exemplary embodiments of the liquid tunable lenses, wherein the curvature of the first interface is controlled by means of electrowetting and the second interface comprises a membrane.

Identical, similar or identically acting elements are provided with the same reference symbols in the figures. The figures and the proportions of the elements shown in the figures among one another are not to be considered to scale. Rather, individual elements can be exaggerated in size for better representation and/or for better comprehensibility.

### DETAILED DESCRIPTION

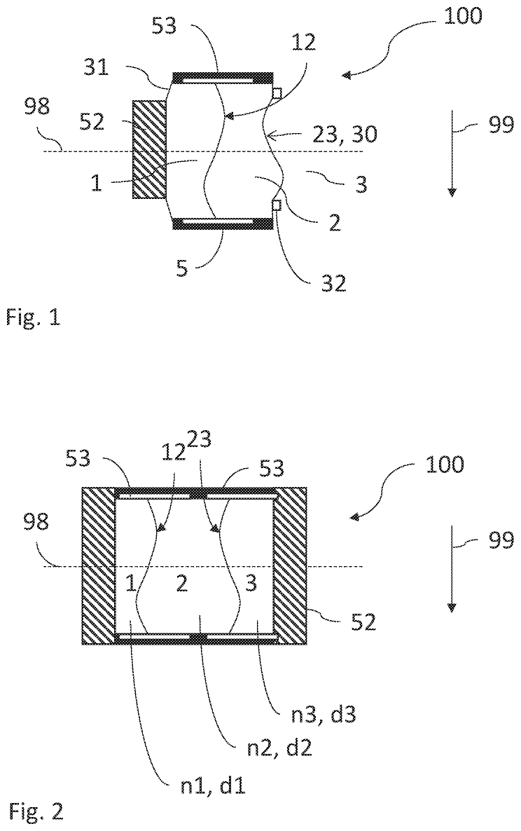

FIG. 1 shows an exemplary embodiment of a tunable lens 100, wherein a first liquid 1 and a second liquid 2 are contained in a volume 50. The volume 50 is delimited by a container 5, having a window element 52 and a membrane 30. The first 1 and the second 2 liquid are directly adjacent to each other and form a first interface 12. The first 1 and the second 2 liquid are immiscible. The curvature of the first interface 12 is altered by means of electrowetting. For this purpose, the container 5 comprises electrodes 53, by means of which the contact angle of the first interface 12 with respect to a lateral wall 51 of the container 5 may be adjusted, to control the curvature of the first interface 12.

On a side facing away from the first interface 12, the second liquid 2 is adjacent to the membrane 30. The curvature of the membrane 30 is altered by displacement of the second liquid 2. In particular, the second liquid is pumped in and out of the volume 50 to alter the curvature of the membrane 30. Alternatively, the lens 100 comprises a lens shaper 32, which is in direct contact with a surface of the membrane 30. The lens shaper may have a frame-like structure and the lens shaper may push or pull on the membrane 30, whereby a concave and/or convex curvature may be altered. The membrane 30 delimits the volume 50 on one side and provides an optical surface. The curvature of the membrane 5 may be controlled by displacement of the liquids within the volume. The liquids may be displaced by directly applying pressure onto the membrane by means of a shaping element. Alternatively, the liquids may be displaced by pumping liquid in and out of the volume 50.

In this embodiment, the third liquid is gaseous, in particular air. In particular, the container 5 is surrounded by the third liquid. The optical properties, in particular the optical power of the lens 100, are adjustable by controlling the shape of the first 12 and the second interface 23.

On a side opposing the membrane 30 along an optical axis 98, a second membrane 31 delimits the volume 50. The window element 52 is mounted on the second membrane 31, whereby the window element 52 may be moved with respect to the container 5. The lens shaper 32 remains in a fixed position with respect to the container 5. Thus, a movement of the window element 52 causes change of the curvature of a section of the membrane, which is surrounded by the lens shaper 32. Thus, a movement of the window element 52 causes a displacement of the liquids in the container 5, which results in a change of the curvature of the second interface 23. The window element 52 is biplanar and rigid. Alternatively, the window element may be a rigid lens having curved surfaces. The liquids 1, 2 in the volume 50, the window element 52 and the membrane 30 are transparent for electromagnetic radiation in at least one common wavelength range. Said wavelength range is preferably in the spectrum of visible light.

The optical axis 98 extends obliquely, in particular perpendicularly, with respect to gravitational force 99. The gravitational force 99 causes a bulge of the first interface 12 and the second interface 23. However, the mass densities and the refractive indices of the liquids 1, 2 comprised in the volume 50 are selected such that the first interface 12 compensates gravitational coma of the second surface 23, or vice versa. In particular, the first liquid 1 has a first refractive index n1 and a first mass density d1, the second liquid 2 has a second refractive index n2 index and a second mass density d2 and the third liquid 3 has a third refractive index n3 and a third mass density d3. The first mass density d1 is smaller than the second mass density d2 and the first refractive index n1 is larger than the second refractive index n2. The second mass density d2 is larger than the third mass density n3 and the second refractive index n2 is smaller than the third refractive index n2.

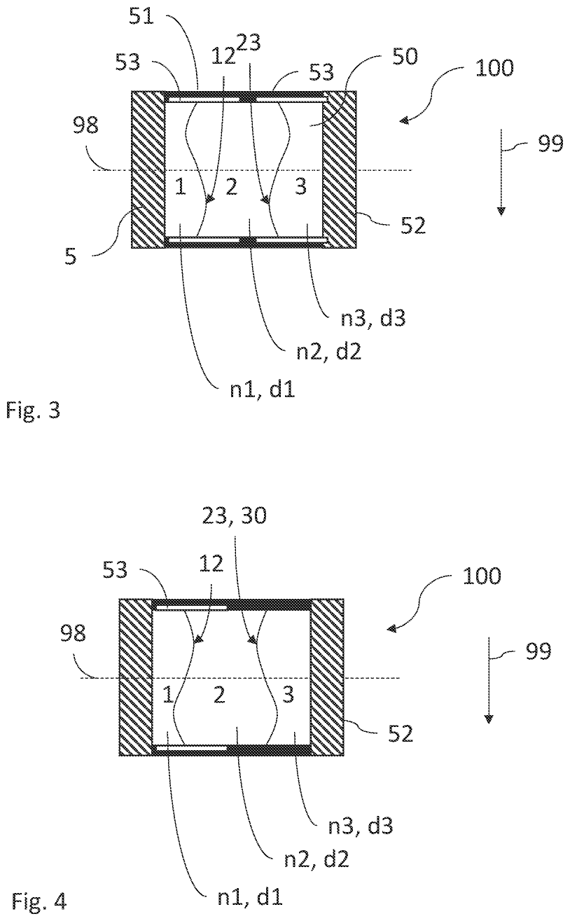

FIG. 2 shows an exemplary embodiment of a tunable liquid lens 100, wherein the optical axis 98 of the lens 100 is arranged perpendicular to the direction of the gravitational force 99. The tunable liquid lens 1 comprises a container 5. The container 5 delimits a volume 50, which is filled with the first liquid 1, the second liquid 2 and the third liquid 3. Between the first liquid 1 and the second liquid 2 the first interface 12 is formed. The first 1 and the second 2 liquid are directly adjacent to each other and the first 1 and the second 2 liquid are immiscible with each other. The first and the second liquid have different refractive indices. Therefore, the first interface 12 is an optical surface. Between the second liquid 2 and the third liquid 3 a second interface 23 is formed. The second 2 and the third 3 liquid are directly adjacent to each other and the second 2 and the third 3 liquid are immiscible with each other. The second and the third liquid have different refractive indices. Therefore, the second interface 23 is an optical surface.

The container 5 comprises electrodes 53. The electrodes 53 are arranged in a lateral wall 51 of the container 2, which surrounds the volume 50 circumferentially. The curvature of the first 12 and the second 23 interface 6 is controlled by means of electrowetting. In other words, the contact angle between the lateral wall 51, the first liquid 1 and the second liquid 2 is controlled by a voltage applied to the electrode 53 and the contact angle between the lateral wall 51, the second liquid 2 and the third liquid 3 is controlled by a voltage applied to the electrode 53. In particular, the electrode 53 may comprise multiple segments, which are arranged circumferentially around the volume. The voltage applied to each segment may be controlled separately. Thus, the said contact angles may be controlled separately at each segment.

The container 5 comprises two window elements 52 which delimit the volume 50 along the optical axis 98 on opposing sides. In particular, the container is hermetically sealed.

The first mass density d1 is smaller than the second mass density d2 and the first refractive index n1 is larger than the second refractive index n2. The second mass density d2 is larger than the third mass density n3 and the third refractive index n3 is smaller than the second refractive index n2.

FIG. 3 shows an exemplary embodiment of a tunable liquid lens 1 in a schematic sectional view. In contrast to the embodiment shown in FIG. 2, the first interface 12 and the second interface 23 bulge in the opposite direction. The first mass density d1 is larger than the second mass density d2 and the first refractive index n1 is smaller than the second refractive index n2. The second mass density d2 is smaller than the third mass density n3 and the second refractive index n2 is larger than the third refractive index n3. The mass densities and the refractive indices of the liquids 1, 2, 3 comprised in the volume 50 are selected such that the first interface 12 compensates gravitational coma of the second interface 23 or vice versa.

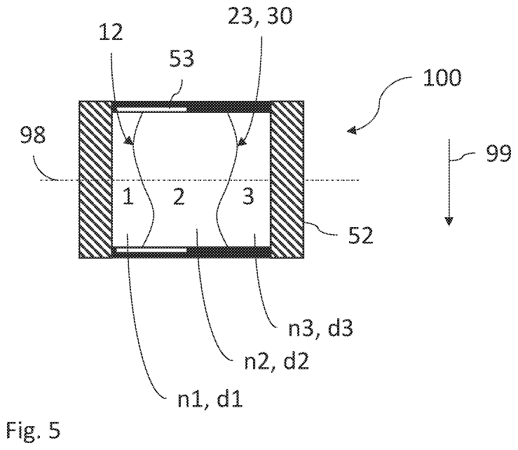

FIG. 4 shows an exemplary embodiment of a tunable liquid lens 1 in a schematic sectional view. By contrast to the embodiment shown in FIG. 1, the volume 50 comprises the third liquid 3. Thus, the volume 50 comprises the first liquid 1 the second liquid 2 and the third liquid 3. The curvature of the first interface is altered by means of electrowetting. The membrane 30 forms the second interface 23 between the second liquid 2 and the third liquid 3. The curvature of the second interface is altered by displacement of the second 2 and/or third 3 liquid.

The gravitational coma of the first interface 12 may be compensated by means of the second interface 23 or vice versa. The refractive indices n1, n2, n3, the mass densities d1, d2, d3 and the stiffness of the membrane 30 are selected such that gravitational coma is compensated. For example, the first mass density d1 is smaller than the second mass density d2 and the first refractive index n1 is larger than the second refractive index n2. The second mass density d2 is larger than the third mass density n3 and the second refractive index n2 is smaller than the third refractive index n3.

FIG. 5 shows an exemplary embodiment of a tunable liquid lens 1 in a schematic sectional view. By contrast to the embodiment shown in FIG. 4 the ratio of the mass densities d1, d2, d3 and the ratio of the refractive indices n1, n2, n3 differ. The gravitational coma of the first interface 12 may be compensated by means of the second interface 23 or vice versa. The refractive indices n1, n2, n3, the mass densities d1, d2, d3 and the stiffness of the membrane 30 are selected such that gravitational coma is compensated. In particular, the first mass density d1 is larger than the second mass density d2 and the first refractive index n1 is smaller than the second refractive index n2. The second mass density d2 is smaller than the third mass density n3 and the second refractive index n2 is larger than the third refractive index n3.

The invention is not restricted to the exemplary embodiments described. Rather, the invention encompasses every new feature and every combination of features, which in particular includes every combination of features in the patent claims, even if this feature or this combination itself is not explicitly specified in the patent claims or exemplary embodiments.

### LIST OF REFERENCE NUMERALS

1 First liquid
2 Second liquid
3 Third liquid
5 Container
12 First interface
23 Second interface
30 Membrane
31 Second membrane
32 Lens shaper
100 Tunable liquid lens
5 Container
50 volume
51 Lateral wall
52 Window element
53 Electrode
98 Optical axis
99 acceleration force
100 liquid tunable lens
n1 first refractive index
n2 second refractive index
n3 third refractive index
d1 first mass density
d2 second mass density
d3 third mass density

We claim:

1. Tunable liquid lens (100) comprising
a container (5) delimiting a volume (50), wherein the volume (50) comprises a first liquid (1) and a second liquid (2),
a first interface (12) is formed between the first liquid (1) and the second liquid (2), wherein the first liquid (1) and the second liquid (2) are immediately adjacent,
a second interface (23) is formed between the second liquid (2) and a third liquid (3), wherein the second liquid (2) and the third liquid (3) are immediately adjacent or the second liquid (2) and the third liquid (3) are adjacent to opposite sides of a membrane (30),
the optical power of the lens (100) is adjustable by altering the curvature of the first interface (12) and/or the second interface (23), and
the refractive indices and the mass densities of the first liquid (1), the second liquid (2) and the third liquid (3) and the stiffness of the membrane (30) are adjusted to compensate for coma induced by acceleration forces (99).

2. Tunable liquid lens according to claim 1, wherein the curvature of the first interface (12) is altered by means of electrowetting.

3. Tunable liquid lens (100) according to claim 1, wherein the second liquid (2) and the third liquid (3) are adjacent to opposite sides of the membrane (30) and the volume (50) comprises the third liquid (3).

4. Tunable liquid lens (100) according to claim 1, wherein the second (2) and the third liquid (3) are adjacent to opposite sides of the membrane (30) and the third liquid (3) is a gas, in particular air.

5. Tunable liquid lens (100) according to claim 3, wherein the curvature of the membrane (30) is altered by displacement of the second liquid and/or third liquid.

6. Tunable liquid lens according to claim 1, wherein
the volume (50) comprises the third liquid (3),
the second liquid (2) and the third liquid (3) are immediately adjacent,
the curvature of the second interface (23) is altered by means of electrowetting.

7. Tunable lens (100) according to claim 1, wherein acceleration forces (99) are gravitational forces.

8. Tunable liquid lens (100) according to claim 1, wherein the container (5) comprises a lateral wall (51), wherein the lateral wall (51) extends circumferentially around the volume (50) and the lateral wall (51) is elastically deformable, particularly such that the elastic deformation of the lateral wall (51) compensates a thermal expansion of the liquids (1, 2, 3) in the volume (50).

9. Tunable liquid lens (1) according to claim 1, wherein
the container (2) comprises a window element (52),
the window element (52) delimits the volume (50) on one side, and
the window element (52) is a rigid transparent biplanar plate or a rigid lens.

10. Tunable liquid lens (1) according to claim 1, characterized in that
the first liquid (3) has a first refractive index (n1) and a first mass density (d1),
the second liquid (4) has a second refractive index (n2) and a second mass density (d2),
the third liquid (3) has a third refractive index (n3) and a third mass density (d3), wherein
the first mass density (d1) is smaller than the second mass density (d2), the first refractive index (n1) is larger than the second refractive index (n2),
the third mass density (d3) is smaller than the second mass density (d2), and
the third refractive index (n3) is larger than the second refractive index (n2).

11. Tunable liquid lens (1) according to claim 1, characterized in that
the first liquid (3) has a first refractive index (n1) and a first mass density (d1),
the second liquid (4) has a second refractive index (n2) and a second mass density (d2),
the third liquid (3) has a third refractive index (n3) and a third mass density (d3), wherein
the first mass density (d1) is larger than the second mass density (d2), and wherein the first refractive index (n1) is smaller than the second refractive index (n2), and
the third mass density (d3) is larger than the second mass density (d2) and the third refractive index (n3) is smaller than the second refractive index (n2).

12. Tunable liquid lens (1) according to claim 9, comprising a second membrane (31), wherein
the second membrane and/or the window element delimits the volume on one side along the optical axis of the tunable liquid lens,
the second membrane is extensively connected to the window element,
the second membrane provides a movable bearing of the window element, which enables the window element to be movable with respect to the lateral wall of the container along the optical axis, and
movement of the window element results in an altered curvature of the second interface.

13. Tunable liquid lens (1) according to claim 1, wherein the first immiscible liquid has a first refractive index and a first mass density, the second immiscible liquid has a second refractive index and a second mass density, and
the first mass density is smaller than the second mass density, and the first refractive index is larger than the second refractive index, or
the first mass density is larger than the second mass density, and wherein the first refractive index is smaller than the second refractive index.
